(19) United States
(12) Patent Application Publication
(10) Pub. No.: US 2026/0343174 A1
(43) Pub. Date: Oct. 29, 2026

(54) DISTANCE EVENT CONFIGURATION AND TRIGGERING METHODS IN WIRELESS COMMUNICATION NETWORK, AND DEVICE

(71) Applicant: CHINA SATELLITE NETWORK INNOVATION CO., LTD, Beijing (CN)

(72) Inventors: Dongqing QI, Beijing (CN); Ge MANG, Beijing (CN); Gaojian WANG, Beijing (CN); Dianting CHI, Beijing (CN); Yihao CHEN, Beijing (CN)

(21) Appl. No.: 19/696,089

(22) Filed: Jun. 2, 2026

Related U.S. Application Data
(63) Continuation of application No. PCT/CN2025/123854, filed on Sep. 25, 2025.

(30) Foreign Application Priority Data
Apr. 24, 2025 (CN) 202510526705.5

(51) Int. Cl. H04W 4/021; H04W 24/10

(52) U.S. Cl. CPC H04W 4/021; H04W 24/10

(57) ABSTRACT

The present disclosure relates to the field of wireless network communication technologies, and provides distance event configuration and triggering methods in a wireless communication network, and a device. The method includes: configuring a distance event including subareas for describing an area; sending a configuration message carrying the distance event to a terminal device, so that the terminal device determines whether to perform a predefined action according to the distance event. Embodiments of the present disclosure can improve the applicable scope of the distance event in the wireless communication network.

### CROSS REFERENCE TO RELATED APPLICATION

The present application is a continuation of International Patent Application No. PCT/CN2025/123854, filed on Sep. 25, 2025, which claims the priority of Chinese Patent Application No. 202510526705.5, entitled “Distance event configuration and triggering methods in wireless communication network, and device” and filed on Apr. 24, 2025, both of which are incorporated herein by reference in their entireties.

### TECHNICAL FIELD

The present disclosure relates to the field of wireless network communication technologies, and particularly, to distance event configuration and triggering methods in a wireless communication network and a device.

### BACKGROUND

In the existing 3^{rd} Generation Partnership Project (3GPP) protocols, a plurality of events for terminal measurement reports are defined, including a distance-based measurement event (hereinafter referred to as distance event). That is, the distance event is one of the conditions that a terminal needs to satisfy when reporting a measurement report. However, the distance event defined in the existing 3GPP protocols is generally only used to describe a terminal approaching a neighbour cell by means of a lunar-shaped area, resulting in a narrow applicable scope.

### SUMMARY

The object of the embodiments of the present disclosure is to provide distance event configuration and triggering methods in a wireless communication network, and a device, so as to improve the applicable scope of distance events in the wireless communication network.

In order to achieve the above object, in an aspect, an embodiment of the present disclosure provides a distance event configuration method in a wireless communication network, which is applied to a network device side, the method including:
configuring a distance event including subareas for describing an area;
sending a configuration message carrying the distance event to a terminal device, so that the terminal device determines whether to perform a predefined action according to the distance event.

In another aspect, an embodiment of the present disclosure further provides a distance event triggering method in a wireless communication network, which is applied to a terminal device side, the method including:
receiving a message carrying a distance event sent by a network device, wherein the distance event includes an area described by a single reference location and a single distance threshold;
determining whether to perform a predefined action according to the distance event.

In still another aspect, an embodiment of the present disclosure further provides a distance event configuration apparatus in a wireless communication network, including:
a configuration module configured to configure a distance event including subareas for describing an area;
a sending module configured to send a configuration message carrying the distance event to a terminal device, so that the terminal device determines whether to perform a predefined action according to the distance event.

In another aspect, an embodiment of the present disclosure further provides a distance event triggering apparatus in a wireless communication network, including:
a receiving module configured to receive a configuration message carrying a distance event sent by a network device, wherein the distance event includes a distance event for describing subareas of an area;
and a determination module configured to determine whether to perform a predefined action according to the distance event.

In another aspect, an embodiment of the present disclosure further provides a network device, including:
at least one processor; and
at least one memory which stores instructions thereon, wherein when executed individually or collectively by the at least one processor, the instructions cause the network device to perform the afore-mentioned distance event configuration method in the wireless communication network.

In another aspect, an embodiment of the present disclosure further provides a terminal device, including:
at least one processor; and
at least one memory which stores instructions thereon, wherein when executed individually or collectively by the at least one processor, the instructions cause the terminal device to perform the afore-mentioned distance event triggering method in the wireless communication network.

In another aspect, an embodiment of the present disclosure further provides a computer storage medium which stores instructions thereon, wherein when executed individually or collectively by at least one processor of a computer device, the instructions cause the computer device to perform the afore-mentioned methods.

As can be seen from the above technical solutions provided by the above embodiments of the present disclosure, in the embodiments of the present disclosure, since the distance event configured by the network device includes subareas for describing an area (instead of only being used to describe a terminal approaching a neighbour cell with a lunar-shaped area as in the existing 3GPP protocols), it thereby enables a more suitable description of inter-layer coverage areas in multi-layer overlapping networking, as well as the refined description of areas within beams or cells (i.e., the subarea may be a coverage area at the cell granularity level or a coverage area at the beam granularity level), so that the applicable scope of distance events in a wireless communication network can be improved.

### BRIEF DESCRIPTION OF DRAWINGS

To illustrate the technical solutions in the embodiments of the present disclosure or in the prior art more clearly, the drawings required to be used in the description of the embodiments or the prior art will be briefly introduced below. Obviously, the drawings involved in the following description merely illustrate some embodiments recited in the present disclosure, and those of ordinary skill in the art can obtain other drawings from these drawings without paying creative efforts. In the drawings:

FIG. 1 illustrates a flowchart of configuration and reporting of Event D1 and Event D2 in the prior art;

FIG. 2 illustrates a schematic diagram of a typical configuration of Event D1 in the prior art;

FIG. 3a illustrates a schematic diagram of the configuration of a circular area (Special Configuration 1) using Event D1 and Event D2 in the prior art;

FIG. 3b illustrates a schematic diagram of the configuration of a circular area (Special Configuration 2) using Event D1 and Event D2 in the prior art;

FIG. 4 illustrates a schematic diagram where a TN small area is included in an NTN small area in the prior art;

FIG. 5 illustrates a schematic diagram of a time-domain distribution of an SSB burst set for downlink coverage enhancement in the prior art;

FIG. 6 illustrates a schematic diagram of a base station and a cell deployment based on downlink coverage enhancement in the prior art;

FIG. 7 illustrates a schematic diagram of a refined measurement gap configuration based on a terminal position in a downlink coverage enhancement scenario in the prior art;

FIG. 8 illustrates a flowchart of a distance event configuration method in a wireless communication network according to some embodiments of the present disclosure;

FIG. 9 illustrates that an entering condition for extended Event D1 can indicate that a terminal is inside a circular area according to an exemplary embodiment of the present disclosure;

FIG. 10 illustrates that an entering condition of extended Event D1 can indicate that a terminal is outside a circular area according to an exemplary embodiment of the present disclosure;

FIG. 11 illustrates that an entering condition of added Event Dx can indicate that a terminal is inside a circular area according to an exemplary embodiment of the present disclosure;

FIG. 12 illustrates a flowchart of a distance event configuration method in a wireless communication network according to some other embodiments of the present disclosure;

FIG. 13a illustrates a schematic diagram of determining that a terminal is located in a beam center area based on a circular area measurement report according to an exemplary embodiment of the present disclosure;

FIG. 13b illustrates a schematic diagram of determining that a terminal is located in a beam edge area based on a circular area measurement report according to an exemplary embodiment of the present disclosure;

FIG. 13c illustrates a schematic diagram of determining that a terminal is located at a beam edge based on a circular area measurement report according to an exemplary embodiment of the present disclosure;

FIG. 13d illustrates a schematic diagram of determining that a terminal is located at a beam edge and close to two neighbour beams (a junction of three circles) based on a circular area measurement report according to an exemplary embodiment of the present disclosure.

FIG. 14 illustrates a flowchart of conditional handover for a circular area-based distance event according to an exemplary embodiment of the present disclosure;

FIG. 15 illustrates a flowchart of a distance event triggering method in a wireless communication network according to some embodiments of the present disclosure;

FIG. 16 illustrates a structural block diagram of a network device according to some embodiments of the present disclosure; and

FIG. 17 illustrates a structural block diagram of a terminal device according to some embodiments of the present disclosure.

### DESCRIPTION OF REFERENCE SIGNS

1600: network device;
1610, 1710: processor;
1620,1720: memory;
1630: program;
1640: transceiver;
1650: antenna;
1700: terminal device;
1730: communication module;
1740: input unit;
1750: display;
1760: power supply.

### DETAILED DESCRIPTION

To enable those skilled in the art to better understand the technical solutions in the present disclosure, the technical solutions in the embodiments of the present disclosure will be described clearly and completely below with reference to the drawings for the embodiments of the present disclosure. Apparently, those described are merely part, rather than all, of the embodiments of the present disclosure. Based on the embodiments in the present disclosure, all other embodiments obtained by those of ordinary skill in the art without making any creative effort shall fall within the protection scope of the present disclosure.

To be noted, in the embodiments of the present disclosure, the involved user information (including but not limited to user device information, user personal information, etc.) and data (including but not limited to data used for analysis, stored data, displayed data, etc.) are all information and data authorized by the user and fully authorized by all parties. That is, the obtaining, transmission, storage, use, processing, etc. of the data in the technical solution of the present disclosure all comply with the relevant provisions of national laws and regulations.

In the description of the present disclosure, unless otherwise specified, "and/or" describes an association relationship between associated objects and indicates that three relationships may exist. For example, A and/or B may indicate the three cases: A exists alone, both A and B exist simultaneously, and B exists alone, where A and B may be singular or plural. In addition, in the description of the present disclosure, unless otherwise specified, "a plurality of" refers to two or more. "At least one of …" or a similar expression refers to any combination of the listed items, including any combination of a single item or a plurality of items. For example, “at least one of a, b, or c” may indicate “a”, “b”, “c”, “a and b”, “a and c”, “b and c”, or “a, b and c”, where each of a, b and c may be singular or plural.

In the present disclosure, the expressions "greater than" or "less than" may be used to determine whether a specific condition is satisfied, but this is merely provided as an example and are not intended to exclude the expressions of "greater than or equal to" or "less than or equal to". A condition described as "greater than or equal to" may be replaced with "greater than"; a condition described as "less than or equal to" may be replaced with "less than"; and a condition described as "greater than or equal to … and less than" may be replaced with "greater than ... and less than or equal to". In addition, hereinafter, "A to B" means at least one of the elements from A (inclusive) to B (inclusive).

In the embodiments of the present disclosure, a singular form such as "a/an" and "the" includes a plural form, and shall be understood in a broad sense as "one kind of" or "one type of" rather than being limited to the meaning of "one single". In addition, the term "said" shall be understood as including both the singular and plural forms unless the context clearly indicates otherwise. Furthermore, the term "according to" shall be understood as "at least in part according to...", and the term "based on" shall be understood as "at least in part based on..." unless the context clearly indicates otherwise.

The specification provides the operation steps of the method as illustrated in the embodiments or the flowcharts, but more or fewer operation steps may be included based on conventional or non-creative efforts. The order of the steps listed in the embodiments is merely one of the numerous possible execution orders and does not represent the sole one. In actual implementation by a system or an apparatus product, the steps may be executed in sequence or in parallel in accordance with the method in the embodiments or shown in the drawings.

To be noted, in the embodiments of the present disclosure, certain existing industry solutions such as software, components and models may be mentioned. These solutions shall be regarded as exemplary, for the only purpose of demonstrating the feasibility of implementing the technical solutions of the present disclosure, but does not mean that the applicant has adopted or necessarily will adopt such solutions.

The present disclosure uses the terms employed in some communication specifications (e.g., the 3rd Generation Partnership Project (3GPP), European Telecommunications Standards Institute (ETSI)), Extensible Radio Access Network (ERAN), Open Radio Access Network (O-RAN) to illustrate various embodiments, which is merely for illustrative purposes. Various embodiments of the present disclosure can also be easily modified and applied in other communication systems.

In the embodiments of the present disclosure, the communications between devices in a communication system may be performed in accordance with communication protocols at any stage, including but not limited to the following communication protocols: 1G (generation), 2G, 2.5G, 2.75G, 3G, 4G, 4.5G and 5G, New Radio (NR), etc., and/or other currently known or future-developed communication protocols.

To facilitate understanding, the technical terms involved in the embodiments of the present disclosure are explained below.

1. Terminal device: refers to a device that has a wireless transceiving function and can cooperate with a network-side device to provide communication services for users. The terminal device may also be referred to as a terminal, User Equipment (UE), a user terminal, a Mobile Terminal (MT), or a user agent. For example, the terminal device may be a mobile phone, a tablet computer, a notebook computer, a wearable device, a Virtual Reality (VR) device, an Augmented Reality (AR) device, a wireless communication device, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, an Internet of Things (IoT) device, a Narrowband Internet of Things (NB-IoT) device, a Vehicle-to-Everything (V2X) device, a device in Device-to-Device Communication (D2D), an Enhanced Machine Type Communication (eMTC) device, a Reduced Capability (RedCap) device, a cellular phone, a cordless phone, a Session Initiation Protocol (SIP) phone, a Wireless Local Loop (WLL) station, a Personal Digital Assistant (PDA), a client, a handheld device with a wireless communication function, a vehicle-mounted device, a ship-borne device, etc.

In scenarios such as the Internet of Things (IoT), the terminal device may also be a machine or apparatus for monitoring or measurement, including but not limited to, for example: a Machine Type Communication (MTC) terminal, a vehicle-mounted communication terminal, a Device to Device (D2D) terminal, a Machine to Machine (M2M) terminal, etc.

2. Network device: refers to a network-side device capable of communicating with the terminal device. The network device may be located on a satellite or on the ground. The network device may also be referred to as a space base station, a satellite-borne base station, a satellite, a satellite communication node, a satellite network terminal device, a satellite communication module, or a base station, etc. The network-side device may also be referred to as an access network device or a radio access network device. The network-side device may be a Base Transceiver Station (BTS) in a Global System for Mobile Communication (GSM) or a Code Division Multiple Access (CDMA) communication system carried by a satellite; a NodeB (NB) in a Wideband Code Division Multiple Access (WCDMA) system carried by a satellite; an evolved NodeB (eNB or eNodeB) in an LTE system carried by a satellite; a base station in a terrestrial network or a Non-Terrestrial Network (NTN), such as a base station (gNB) in a 5G network carried by a satellite; a base station in a future network (e.g., a 6G network) after the 5G network carried by a satellite; a base station in a future-evolved Public Land Mobile Network (PLMN) carried by a satellite; a Transmission Reception Point (TRP) carried by a satellite; a radio controller in the scenario of a Cloud Radio Access Network (CRAN) carried by a satellite; or an urban base station, a micro base station, a pico base station or a femto base station carried by a satellite, etc. The base station may also be a terrestrial base station capable of communicating with a satellite, and may also be referred to as an Access Point (AP), a 5th generation (5G) node, a wireless point, a Transmission/Reception Point (TRP), or other terms with an equivalent technical meaning. The network device may also be a base station device carried by a High Altitude Platform Station (HAPS) with a loitering capability such as a large balloon or an airship; a base station device in a Roadside Unit (RSU); or a base station device in the Vehicle-to-Everything (V2X), etc.

Both the terminal device and the base station device may perform beamforming, but the embodiments of the present disclosure are not limited thereto. In some embodiments, the terminal may or may not perform beamforming. Likewise, the base station may or may not perform beamforming. That is, only one of the terminal and the base station may perform beamforming, or neither the terminal nor the base station may perform beamforming. In the present disclosure, a beam refers to the spatial propagation of a signal in a wireless channel, which is formed by one or more antennas or antenna elements, and this formation process may be referred to as beamforming.

In addition, the term "network side" or "network device side" refers to the side of the network, which may be a certain base station, or may include one or more network devices as mentioned above. The term "terminal side" or "terminal device side" refers to the side of the user or terminal, which may be a certain UE, or may include one or more terminal devices as mentioned above.

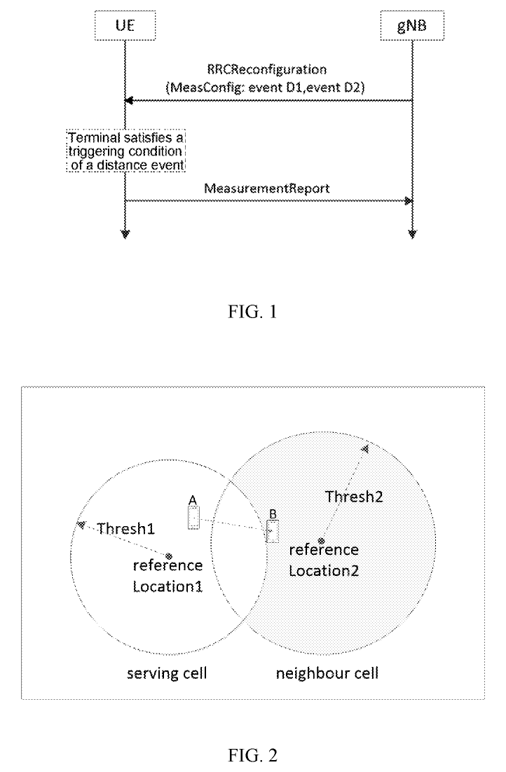

As illustrated in FIG. 1, based on the distance event defined in the existing 3GPP protocols, a network device (gNB in FIG. 1) may send a measurement configuration (MeasConfig) to a terminal device (UE in FIG. 1) via a reconfiguration message (RRCReconfiguration). In which, the measurement configuration mainly includes a measurement object (MeasObject) and a report configuration (ReportConfig). The ReportConfig includes the conditions of the distance event that need to be satisfied for the UE to report a measurement report; of course, it may also be configured to include other events (e.g., a signal strength event) as required, but the present disclosure is primarily directed to the distance event. When identifying, by means of positioning and distance measurement, that the conditions of the distance event (e.g., inequality conditions) configured in the ReportConfig are satisfied, the UE sends a measurement report message to the gNB. The gNB may obtain the area range where the UE is located through the measurement report of the distance event, and trigger the UE to execute a predefined action procedure such as cell handover accordingly.

In the existing 3GPP protocols, two types of events for distance measurement reports are defined: Event D1 and Event D2. In which, Event D1 and Event D2 are configured in a ReportConfigNR field of RRCReconfiguration. For example, when used to trigger a measurement report, Event D1 and Event D2 are configured in an EventTriggerConfig subfield of the ReportConfigNR field. For another example, when used to trigger Conditional Handover (CHO), Event D1 and Event D2 are configured in the CondTriggerConfig subfield of the ReportConfigNR field. Therefore, the judgment conditions for the events used for measurement reports or conditional handover are the same, and the configuration parameter structures are similar, the former is used to trigger the terminal to send a measurement report, and the latter is used to trigger the terminal to perform conditional handover. For the definitions and the specific parameters of these two events, please refer to the definitions of Event D1 and Event D2 in the 3GPP protocols.

With reference to FIG. 2, in the existing 3GPP protocols, two reference locations are configured in the ReportConfig within the measurement configuration for the terminal by a serving cell: reference location 1 (referenceLocation1) and reference location 2 (referenceLocation2). In addition, two distance thresholds are further configured in the ReportConfig: distance threshold 1 (distanceThreshFromReference1, abbreviated as Thresh1) and distance threshold 2 (distanceThreshFromReference2, abbreviated as Thresh2). The afore-mentioned reference locations and distance thresholds can be used to define an entering condition and a leaving condition in a distance event, i.e., the entering condition and the leaving condition can be expressed based on the inequality conditions described by the reference locations and the distance thresholds.

In the existing 3GPP protocols, the referenceLocation1 is required to be associated with the serving cell, and the referenceLocation2 is required to be associated with a neighbour cell. The reasons lie in that the circular area formed with the referenceLocation1 as a center and the distanceThreshFromReference1 as a radius is generally used to represent the coverage area of the serving cell, and the circular area formed with the referenceLocation2 as a center and the distanceThreshFromReference2 as a radius is generally used to represent the coverage area of the neighbour cell. When the terminal identifies by distance measurement that a distance from the terminal to the referenceLocation1 exceeds the distanceThreshFromReference1 (Inequality D1 in the 3GPP protocols) and a distance from the terminal to the referenceLocation2 is less than the distanceThreshFromReference2 (Inequality D1 in the 3GPP protocols), the entering condition for Event D1 is deemed to be satisfied, i.e., the terminal is considered to have entered the coverage area of the neighbour cell. When the entering condition is satisfied and remains so for longer than a configurable trigger time (timeToTrigger), the terminal reports a measurement report. In this way, the base station can know from the measurement report of Event D1 triggered by the terminal that the terminal has moved from the coverage area of the serving cell to a target cell, and make a decision on cell handover based on this information.

With reference to FIG. 2, in a typical Event D1 configuration in the existing 3GPP protocols, the Inequality D1 and the Inequality D1 form two circular areas. After the terminal moving into a lunar-shaped area formed by these two circular areas (the gray area in FIG. 2), the entering condition of Event D1 will be satisfied and the terminal reports a measurement report. The terminal triggers the measurement report of Event D1 when moving from point A to the lunar-shaped area where point B is located.

In the existing 3GPP protocols, the trigger conditions for Event D2 are similar to those for Event D1. The difference lies in that the two reference locations in Event D1 are fixed reference locations, and the two reference locations in Event D2 are moving reference locations (movingReferenceLocation) that move along with the movement of a satellite or the like.

However, Event D1 and Event D2 as defined in the existing 3GPP protocols have the following problems.

I. The existing Event D1 and Event D2 cannot directly represent a circular area.

Event D1 and Event D2 in the existing 3GPP protocols are applicable to describing a terminal approaching a neighbour cell by means of a lunar-shaped area as mentioned above. However, in NTN network communications such as satellite networks, there are many scenarios that require the description of a circular area. Although a circular area can also be configured using Event D1 and Event D2 with the special configurations proposed below, since Event D1 and Event D2 consist of two inequality conditions while only one condition is needed for configuring a circular area, in accordance with the existing definitions of Event D1 and Event D2, the terminal will continuously perform position tracking and calculation for an invalid distance condition when expressing the circular area, thus wasting resources such as the computing power of the terminal. Further, in this case, the base station also needs to specially calculate a set of special configurations for invalidating the inequality conditions, which are specified as follows.

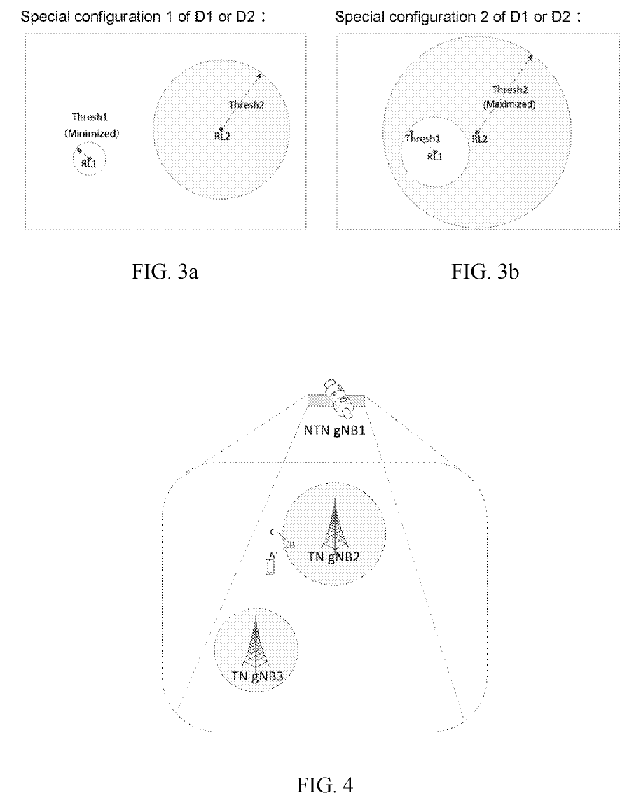

Special Configuration 1: Taking Event D1 as an example (similar for Event D2), Thresh1 (distanceThreshFromReference1) is configured to be as small as possible, so that Inequality D1-1 is always true. That is, the entering condition of Event D1 is only associated with Inequality D1. In this case, the entering condition of Event D1 may be degraded to an inner area of a circular area (as illustrated in FIG. 3a). Nevertheless, as the terminal moves or the reference location configured for Event D2 moves, the terminal still needs to continuously perform invalid calculations for Inequality D1. In FIG. 3a, RL1 is a reference location 1, RL2 is a reference location 2, Thresh1 is a distance threshold 1, and Thresh2 is a distance threshold 2.

In which, in EventTriggerConfig of the existing 3GPP protocols, a minimum value of distanceThreshFromReference1-r17 for eventD1-r17 can be configured as 1, which represents 50 meters; and a minimum value of distanceThreshFromReference1-r18 for eventD2-r18 can also be configured as 1, which represents 50 meters. In addition, configuring such excessively small distance thresholds raises privacy and security concerns due to the exposure of the position of the terminal.

Special Configuration 2: Still taking Event D1 as an example, Thresh2 (distanceThreshFromReference2) is configured as large as possible, so that Inequality D1 is always true. That is, the entering condition of Event D1 is only associated with Inequality D1. In this case, the entering condition of Event D1 is degraded to an outer area of a circular area (as illustrated in FIG. 3b). Nevertheless, as the terminal moves or the reference location configured for Event D2 moves, the terminal needs to continuously perform invalid calculations for Inequality D1. In FIG. 3b, RL1 is a reference location 1, RL2 is a reference location 2, Thresh1 is a distance threshold 1, and Thresh2 is a distance threshold 2.

In which, in EventTriggerConfig of the existing 3GPP protocols, a maximum value of distanceThreshFromReference2-r17 for eventD1-r17 can be configured as 65525, which represents 65525*50/1000=3276.25 kilometers; and a maximum value of distanceThreshFromReference1-r18 for eventD2-r18 is 65535, which represents 65535*50/1000=3276.75 kilometers.

II. The existing Event D1 and Event D2 impose excessive restrictions on the reference locations.

In Event D1 and Event D2 of the existing 3GPP protocols, the reference locations are described as that "referenceLocation1 is associated with a serving cell, and referenceLocation2 is associated with a neighbour cell". Consequently, Event D1 and Event D2 of the existing 3GPP protocols are only suitable for describing the inter-cell adjacent deployment, but not for the description of scenarios such as inter-cell overlapping deployment or beam-level coverage areas, thus restricting the application scenarios of the distance events.

Example 1 of problematic scenario (not supporting the description of a multi-layer network with overlapping coverage)

As illustrated in FIG. 4, the coverage area of an NTN base station (NTN gNB1 in FIG. 4) is generally much larger than that of a terrestrial base station (TN gNB2 in FIG. 4), and the coverage area of the NTN base station is highly likely to contain the coverage areas of one or more TN base stations (TN gNB2 and TN gNB3 in FIG. 4). An NTN base station needs to monitor the situation where a terminal in an RRC_CONNECTED state served thereby enters or leaves the coverage area of the TN base station. A typical monitoring process is as follows.

Firstly, for a terminal that has established an RRC connection with an NTN cell and is far from a TN cell (e.g., at Position A in FIG. 4), the NTN cell does not expect the terminal to hand over to the TN cell. The NTN cell may not configure the terminal for signal strength measurement on TN frequency points (as inter-frequency measurement made by the terminal may affect the communication with the serving cell). In this case, the NTN cell may configure Event D1 for the terminal to monitor whether the terminal enters the TN cell. For Event D1 in this scenario, referenceLocation2 may be configured as a center of the TN base station, and distanceThreshFromReference2 may be configured as a coverage radius of the TN base station (the coverage area of the TN base station is simplified as a circle). The configuration of referenceLocation1 or distanceThreshFromReference1 is not required at all. However, since the existing 3GPP protocols do not support such a configuration mode that ignores referenceLocation1 and distanceThreshFromReference1, the NTN cell still needs to configure these two redundant parameters for the terminal, while ensuring that Inequality D1 needs to be always true, which wastes the computing power of both the base station and the terminal simultaneously.

Secondly, when the terminal enters the TN cell (e.g., at Position B in FIG. 4), the terminal reports a measurement report of Event D1. After receiving the measurement report of Event D1, the NTN cell may configure the terminal to perform signal strength measurement on TN frequency points. After receiving the terminal's signal strength measurement report on the TN neighbour cell again, the NTN cell determines whether to hand over the terminal to a TN network according to the terminal's signal strength measurement report on the TN neighbour cell.

Next, the terminal located at the boundary of the TN cell and the NTN cell and connected to the NTN network (e.g., the terminal at Position B in FIG. 4) may hand over to the TN cell and may also move back to the NTN cell (e.g., to Position C in FIG. 4). In this case, the NTN cell may configure another Event D1 for the terminal to monitor whether the terminal enters the area outside the circular region. For Event D1 in this scenario, the simplest way is to configure referenceLocation1 as the center of the coverage area of the TN base station, and configure distanceThreshFromReference1 as the coverage radius of the TN base station, but this would violate the constraint that referenceLocation1 needs to be associated with the serving cell. On the other hand, the configuration of referenceLocation2 and distanceThreshFromReference2 is actually not required at all. However, since the existing 3GPP protocols do not support such a configuration omission, the base station still needs configure these two values for the terminal while ensuring that Inequality D1 always remains true. This also wastes the computing power of both the base station and the terminal simultaneously.

Example 2 of problematic scenario (not supporting the description of a beam-granularity area)

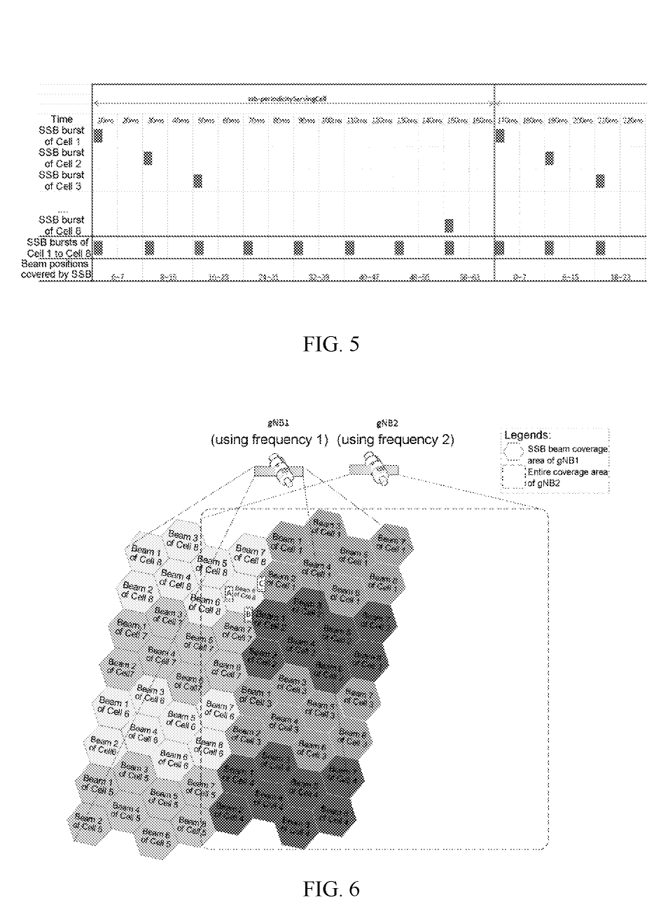

To meet the requirements for NTN downlink coverage enhancement, the existing 3GPP protocols have determined, in Release 19 (a 5G Advanced standard), the expansion of the default period of a Synchronization Signal/PBCH Block (SSB) from 20 ms to 160 ms. As illustrated in FIG. 5, when the SSB period is set to 160 ms, an SSB appears once every 160 ms from the perspective of a terrestrial terminal; and from the perspective of the base station, 8 SSBs can still be transmitted every 20 ms, and these 8 SSBs constitute an SSB burst set (SSB burst) that belongs to the same cell. The 8 SSB bursts within a period of 160 ms belong to 8 asynchronous cells respectively, and each cell can serve 8 beam positions (i.e., beam coverage areas). In this way, the base station can serve up to 64 beam positions within the period of 160 ms to achieve downlink coverage enhancement.

The technology of downlink coverage enhancement can increase the coverage area of the NTN base station, but the SSB bursts of different cells are distributed across different periods of 20 ms, which makes the configuration of measurements for the neighbour cells more complex, and the configuration of measurement gap (MeasGapConfig) is one of the resulting issues.

Taking the scenario of downlink coverage enhancement with the SSB period of 160 ms as an example, a typical cell deployment is illustrated in FIG. 6, wherein gNB1 consists of a plurality of mutually asynchronous cells, the SSBs of each cell use a same frequency (frequency1), and each cell covers 8 beam positions. A certain Terminal A camps on another gNB2 (which may be a TN base station or an NTN base station), and the SSBs of gNB2 are deployed on a frequency (frequency2) different from that of gNB1. Terminal A establishes a connection on the cell of gNB2, remains in the RRC_CONNECTED state, and needs to perform inter-frequency measurements on the SSBs of NTN gNB1 for cell handover from gNB2 to gNB1.

With continued reference to FIG. 6, when gNB2 configures the measurement gaps targeting gNB1 for the terminal, an overly coarse configuration granularity will result in the terminal being configured with many measurement windows for the neighbour cells which are difficult to measure from the position of the terminal, thus leading to severe resource waste. When the base station can configure precise measurement windows for each terminal based on the position of the terminal, the number of invalid measurement gaps received by the terminal will be significantly reduced.

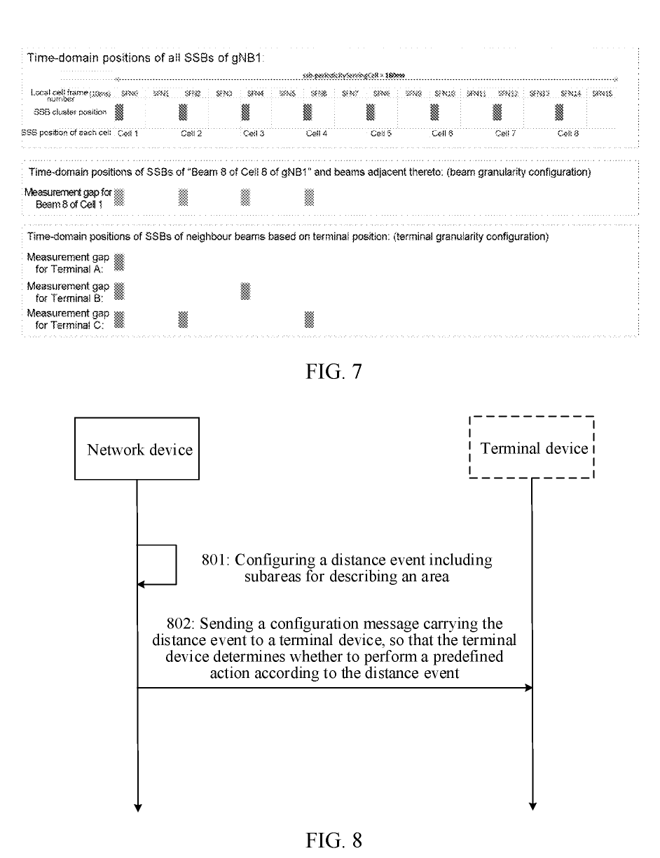

As illustrated in FIG. 7, when the measurement gaps are configured at the granularity of the beams of gNB1 or the service area of gNB2, Terminals A, B and C in FIG. 7 all need to be configured with 4 measurement gaps within a period of 160 ms, resulting in many invalid measurement gaps. If the base station can configure the measurement gaps according to the position of the terminal, only 1 SSB burst may be measured within the period of 160 ms for a terminal located at the center of a beam; only 2 SSB bursts may be measured within the period of 160 ms for a terminal located at the edge of two beams; and only 3 SSB bursts may be measured within the period of 160 ms for a terminal located at the edge of three beams. It can be seen that the invalid configuration of the measurement gaps can be greatly reduced. However, configuring the measurement gaps based on the position of the terminal will increase the complexity of the base station, for example, the base station needs to track the position of the terminal. In addition, there are security and privacy constraints on the terminal reporting its own position, making engineering implementation rather difficult.

Identifying the beam coverage area where the terminal is located based on Event D1 or Event D2 would be much simpler: the terminal triggers a measurement report according to changes in its own position, and the measurement report only reports the general area where the terminal is located without exposing the specific position of the terminal. However, such a simplified configuration would violate the description constraints on the reference locations in the existing 3GPP protocols (referenceLocation1 is associated with the serving cell, and referenceLocation2 is associated with the neighbour cell). This is because the reference locations at this time are all associated with the neighbour cell (e.g., may be the beam position center or the beam center of the neighbour cell), and have no direct connection with the serving cell, such that the prior arts also do not support such a configuration. On the other hand, the beam coverage area is usually approximately circular rather than approximately lunate, and there is also the problem that one of the two conditions needs to be ignored when describing a circular area with the existing Event D1 and Event D2.

In view of this, to improve the applicable scope of distance events in a wireless communication network, the embodiments of the present disclosure propose configuration and triggering schemes for circular area-based distance events in a wireless communication network.

An embodiment of the present disclosure provides a distance event configuration method in a wireless communication network, which can be applied to the network device side described above. As illustrated in FIG. 8, in some embodiments of the present disclosure, the distance event configuration method in the wireless communication network may include the following steps.

Step 801: Configuring a distance event including subareas for describing an area.

Step 802: Sending a configuration message carrying the distance event to a terminal device, so that the terminal device determines whether to perform a predefined action according to the distance event.

In the embodiments of the present disclosure, since the distance event configured by a network device includes subareas for describing an area (instead of only being used to describe a terminal approaching a neighbour cell with a lunar-shaped area as in the existing 3GPP protocols), it thereby enables a more suitable description of inter-layer coverage areas in multi-layer overlapping networking and the refined description of areas within beams or cells (i.e., the subarea may be a coverage area at the cell granularity level or a coverage area at the beam granularity level), so that the applicable scope of distance events in a wireless communication network can be improved.

In some embodiments of the present disclosure, the configuring a distance event including subareas for describing an area may include: configuring a distance event including a circular subarea described by a single reference location and a single distance threshold. In this way, each event only requires the terminal to judge a distance to one reference location (latitude and longitude coordinates), which is simpler compared with the existing Event D1 and Event D2. Therefore, this not only improves the applicable scope of distance events in a wireless communication network but also reduces the computational overhead of the terminal for position calculation.

I. Circular area-based distance events extended from existing Event D1 and Event D2

In some embodiments of the present disclosure, the configuring a distance event including a circular subarea described by a single reference location and a single distance threshold may include: ignoring a part of conditions in an original distance event (Event D1 and Event D2) based on indication information, so that the original distance event includes a circular subarea described by a single reference location and a single distance threshold.

Specifically, a part of the conditions in the original Event D1 and Event D2 may be ignored by adding an indication, so that both the original Event D1 and Event D2 are extended to include a circular subarea described by a single reference location and a single distance threshold. As a result, the extended Event D1 can indicate that the terminal is inside or outside a fixed circular area on the ground, and the extended Event D2 can also indicate that the terminal is inside or outside a movable circular area on the ground. When the terminal judges the extended Event D1 or Event D2, it only needs to judge one of the two conditions for the same distance event, i.e., judging a distance between itself and one of the reference locations, thereby saving the computational overheads of both the terminal and the base station for position calculation.

In some embodiments of the present disclosure, ignoring a part of the conditions in the original Event D1 and Event D2 by adding an indication may specifically include:

1. An “added indication 1” is defined to indicate that condition D1 (i.e., Inequality D1 in the 3GPP protocols) is always true, and condition D1 (i.e., Inequality D1 in the 3GPP protocols) is always false. When judging this Event D1, the terminal does not need to calculate the distance between itself and referenceLocation1.

When judging the entering condition of this Event D1, the terminal only needs to consider condition D1 (i.e., Inequality D1 in the 3GPP protocols), without considering condition D1 (because it is always true).

When judging the leaving condition of this Event D1, the terminal only needs to consider condition D1-4 (i.e., Inequality D1-4 in the 3GPP protocols), without considering condition D1-3 (because it is always false).

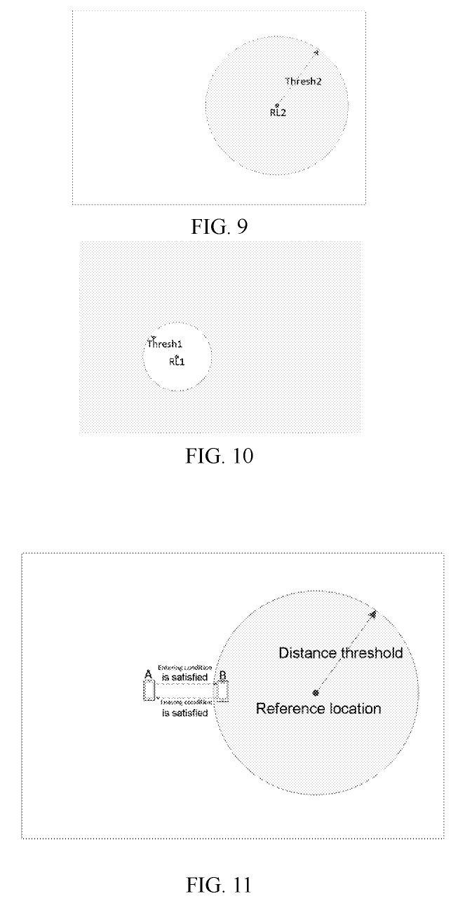

When the base station configures the “added indication 1”, the entering condition of Event D1 becomes the interior of a circular area (a gray area as illustrated in FIG. 9). In FIG. 9, RL2 is a fixed reference location 2, and Thresh2 is a distance threshold 2.

2. An “added indication 2” is defined to indicate that condition D1-2 is always true, and condition D1-4 is always false. When judging this Event D1, the terminal does not need to calculate the distance between itself and referenceLocation2.

When judging the entering condition of this Event D1, the terminal only needs to consider condition D1-1, without considering condition D1-2 (because it is always true).

When judging the leaving condition of this Event D1, the terminal only needs to consider condition D1-3, without considering condition D1-4 (because it is always false).

When the base station configures the “added indication 2”, the triggering condition of Event D1 becomes the exterior of a circular area (a gray area as illustrated in FIG. 10). In FIG. 10, RL1 is a fixed reference location 1, and Thresh1 is a distance threshold 1.

It is required that the base station shall not configure the “added indication 1” and the “added indication 2” simultaneously for the same Event D1 during configuration.

3. An “added indication 3” is defined to indicate that condition D2-1 (i.e., Inequality D2-1 in the 3GPP protocols) is always true, and condition D2-3 (i.e., Inequality D2-3 in the 3GPP protocols) is always false. When judging this Event D2, the terminal does not need to calculate the distance between itself and a serving cell moving reference location.

When judging the entering condition of this Event D2, the terminal only needs to consider condition D2-2 (i.e., Inequality D2-2 in the 3GPP protocols), without considering condition D2-1 (because it is always true).

When judging the leaving condition of this Event D2, the terminal only needs to consider condition D2-4 (i.e., Inequality D2-4 in the 3GPP protocols), without considering condition D2-3 (because it is always false).

When the base station configures the “added indication 3”, the triggering condition of Event D2 becomes the interior of a circular area. The corresponding illustration is the same as that for the “added indication 1”, with the difference that the reference location 2 is a moving reference location.

4. An “added indication 4” is defined to indicate that condition D2-2 is always true, and condition D2-4 is always false. When judging this Event D2, the terminal does not need to calculate the distance between itself and the moving reference location.

When judging the entering condition of this Event D2, the terminal only needs to consider condition D2-1, without considering condition D2-2 (because it is always true).

When judging the leaving condition of this Event D2, the terminal only needs to consider condition D2-3, without considering condition D2-4 (because it is always false).

When the base station configures the “added indication 4”, the triggering condition of Event D2 becomes the exterior of a circular area. The corresponding illustration is the same as that for the “added indication 2”, with the difference that the reference location 1 is a moving reference location.

It is required that the base station shall not configure the “added indication 3” and the “added indication 4” simultaneously for the same Event D2 during configuration.

For the above “added indications”, the embodiments of the present disclosure propose a plurality of indication modes, which are specifically described as follows.

I. Indication mode 1 (implicitly expressing an added indication by configuring a distance threshold to be a specific value)

In some embodiments of the present disclosure, ignoring a part of conditions in an original distance event based on indication information may include: ignoring a part of conditions in the original distance event by indicating that a distance threshold in the original distance event is a specific value. In this way, the modifications to the existing 3GPP protocols can be reduced, thereby being easy to implement.

In some embodiments of the present disclosure, the ignoring a part of conditions in the original distance event by indicating that a distance threshold in the original distance event is a specific value may specifically include:

1. Configuring a distance threshold corresponding to a first fixed reference location in the original first distance event to be a first specific value, to indicate that in the original first distance event, a first condition is always true and a second condition is always false;
wherein the original first distance event is: eventD1 in the 3GPP;
the first fixed reference location is: fixed referencelocation1 associated with a serving cell in eventD1;
the distance threshold corresponding to the first fixed reference location is: distanceThreshFromReference1 in eventD1;
the first condition is: Ml11-Hys>Thresh11, i.e., the first condition is Inequality D1-1 in eventD1;
the second condition is: Ml11+Hys<Thresh11, i.e., the second condition is Inequality D1-3 in eventD1;
the first specific value is a predefined value; for example, when the first specific value is configured as a minimum value (or a maximum value or any other special value) within a value range, it indicates that the base station has configured the “added indication 1”.

2. Configuring a distance threshold corresponding to a second fixed reference location in the original first distance event to be a second specific value, to indicate that in the original first distance event, a third condition is always true and a fourth condition is always false;
wherein the original first distance event is: eventD1 in the 3GPP;
the second fixed reference location is: fixed referencelocation2 associated with a neighbour cell in eventD1;
the distance threshold corresponding to the second fixed reference location is: distanceThreshFromReference2 in eventD1;
the third condition is: Ml12+Hys<Thresh12, i.e., the third condition is Inequality D1-2 in eventD1;
the fourth condition is: Ml12-Hys>Thresh12, i.e., the fourth condition is Inequality D1-4 in eventD1;
the second specific value is a predefined value; for example, when the second specific value is configured as a maximum value (or a minimum value or any other special value) within a value range, it indicates that the base station has configured the “added indication 2”.

3. Configuring a distance threshold corresponding to a first moving reference location in an original second distance event to be a third specific value, to indicate that in the original second distance event, a fifth condition is always true and a sixth condition is always false;
wherein the original second distance event is: eventD2 in the 3GPP;
the first moving reference location is: a moving reference location associated with a serving cell in eventD2, i.e., movingReferenceLocation in SIB19;
the distance threshold corresponding to the first moving reference location is: distanceThreshFromReference1 in eventD2;
the fifth condition is: Ml21-Hys>Thresh21, i.e., the fifth condition is Inequality D2-1 in eventD2;
the sixth condition is: Ml21+Hys<Thresh21, i.e., the sixth condition is Inequality D2-3 in eventD2;
the third specific value is a predefined value; for example, when the third specific value is configured as a minimum value (or a maximum value or any other special value) within a value range, it indicates that the base station has configured the “added indication 3”.

4. Configuring a distance threshold corresponding to a second moving reference location in the original second distance event to be a fourth specific value, to indicate that in the original second distance event, a seventh condition is always true and an eighth condition is always false;
wherein the original second distance event is: eventD2 in the 3GPP;
the second moving reference location is: a moving reference location associated with a neighbour cell in eventD2, i.e., referencelocation in measObjectNR;
the distance threshold corresponding to the second moving reference location is: distanceThreshFromReference2 in eventD2;
the seventh condition is: Ml22+Hys<Thresh22, i.e., the seventh condition is Inequality D2-2 in eventD2;
the eighth condition is: Ml22-Hys>Thresh22, i.e., the eighth condition is Inequality D2-4 in eventD2;
the fourth specific value is a predefined value; for example, when the fourth specific value is configured as a maximum value (or a minimum value or any other special value) within a value range, it indicates that the base station has configured the “added indication 4”;
wherein Ml11 is a distance between the terminal device and the first fixed reference location, Hys is a distance hysteresis parameter, Thresh11 is a distance threshold corresponding to the first fixed reference location, Ml12 is a distance between the terminal device and the second fixed reference location, Thresh12 is a distance threshold corresponding to the second fixed reference location, Ml21 is a distance between the terminal device and the first moving reference location, Thresh21 is a distance threshold corresponding to the first moving reference location, Ml22 is a distance between the terminal device and the second moving reference location, and Thresh22 is a distance threshold corresponding to the second moving reference location.

In which, the above specific value being a maximum value or a minimum value is merely an illustrative example, it does not restrict which specific numerical value is used.

In some embodiments of the present disclosure, configuring the specific value of the distance threshold as a maximum value or a minimum value may refer to the maximum value or the minimum value within the corresponding value range in the original 3GPP protocols.

In some other embodiments of the present disclosure, the value range of the corresponding distance threshold in the original 3GPP protocols may be extended, and a specific value (e.g., a minimum value of the distance threshold after extension) may be selected from the extended value range of the distance threshold. For example, in the original 3GPP protocols, the value ranges of both distanceThreshFromReference1 and distanceThreshFromReference2 are 1 to 65525 and may be extended to 0 to 65525, and a minimum value 0 within the value range of 0 to 65525 may be used as the specific value of distanceThreshFromReference1 or distanceThreshFromReference2, to implicitly express the added indication by configuring the distance threshold to be the specific value.

II. Indication mode 2 (implicitly expressing an added indication by configuring the position of a reference location to be a specific value)

In some embodiments of the present disclosure, the ignoring a part of conditions in an original distance event based on indication information may include: ignoring a part of conditions in an original distance event by indicating that the position of a reference location in the original distance event is a specific value. In this way, the modifications to the existing 3GPP protocols can also be reduced, thereby being easy to implement.

In some embodiments of the present disclosure, the ignoring a part of conditions in an original distance event by indicating that the position of a reference location in the original distance event is a specific position value may specifically include:
1. configuring a position of a first fixed reference location in an original first distance event to be a fifth specific value, to indicate that in the original first distance event, a first condition is always true and a second condition is always false;
2. configuring a position of a second fixed reference location in the original first distance event to be a sixth specific value, to indicate that in the original first distance event, a third condition is always true and a fourth condition is always false;
3. configuring a position of a first moving reference location in an original second distance event to be a seventh specific value, to indicate that in the original second distance event, a fifth condition is always true and a sixth condition is always false;
4. configuring a position of a second moving reference location in the original second distance event to be an eighth specific value, to indicate that in the original second distance event, a seventh condition is always true and an eighth condition is always false.

In which, the relevant concepts in the indication mode 2 (e.g., the reference location, the condition, etc.) may refer to those in the indication mode 1 as described above, and will not be repeated here.

In some embodiments of the present disclosure, configuring the specific value of the position of the reference location as a maximum value or a minimum value may refer to a maximum value or a minimum value within the value range of the position of the corresponding reference location in the original 3GPP protocols.

In some other embodiments of the present disclosure, the value range of the position of the corresponding reference location in the original 3GPP protocols may also be extended, and a specific value (e.g., a minimum value of the position of the reference location after extension) may be selected from the extended value range of the position of the reference location.

III. Indication mode 3 (implicitly expressing an added indication by configuring the distance threshold and the reference location to satisfy a specific relationship)

In some embodiments of the present disclosure, the ignoring a part of conditions in an original distance event based on indication information may include: ignoring a part of conditions in an original distance event by indicating that a distance threshold and a reference location in the original distance event satisfy a specific relationship. In this way, the modifications to the existing 3GPP protocols can be reduced, thereby being easy to implement and helping to reduce misunderstandings of the indication.

In some embodiments of the present disclosure, the ignoring a part of conditions in an original distance event by indicating that a distance threshold and a reference location in the original distance event satisfy a specific relationship may specifically include:

1. Configuring to satisfy an inequality Thresh11+ Thresh12<R1 in an original first distance event, to indicate that in the original first distance event, a first condition is always true and a second condition is always false;
wherein the original first distance event is: eventD1 in the 3GPP;
Thresh11 is a distance threshold corresponding to a first fixed reference location (referencelocation1, a fixed reference location associated with a serving cell in eventD1), i.e., distanceThreshFromReference1 in eventD1;
Thresh12 is a distance threshold corresponding to a second fixed reference location (referencelocation2, a fixed reference location associated with a neighbour cell in eventD1), i.e., distanceThreshFromReference2 in eventD1;
R1 is a distance between the first fixed reference location and the second fixed reference location;
the first condition is: Ml11-Hys>Thresh11, i.e., the first condition is Inequality D1-1 in eventD1;
the second condition is: Ml11+Hys<Thresh11, i.e., the second condition is Inequality D1-3 in eventD1.

When a sum of distanceThreshFromReference1 and distanceThreshFromReference2 configured for Event D1 is less than the distance between referenceLocation1 and referenceLocation2, it indicates that the base station has configured the “added indication 1”.

2. Configuring to satisfy an inequality Thresh12- Thresh11>R1 in the original first distance event, to indicate that in the original first distance event, a third condition is always true and a fourth condition is always false;
wherein the original first distance event is: eventD1 in the 3GPP;
Thresh12 is a distance threshold corresponding to a second fixed reference location (referencelocation2, a fixed reference location associated with a neighbour cell in eventD1), i.e., distanceThreshFromReference2 in eventD1;
Thresh11 is a distance threshold corresponding to a first fixed reference location (referencelocation1, a fixed reference location associated with a serving cell in eventD1), i.e., distanceThreshFromReference1 in eventD1;
R1 is a distance between the first fixed reference location and the second fixed reference location;
the third condition is: Ml12+Hys<Thresh12, i.e., the third condition is Inequality D1-2 in eventD1;
the fourth condition is: Ml12-Hys>Thresh12, i.e., the fourth condition is Inequality D1-4 in eventD1.

When a difference obtained by subtracting distanceThreshFromReference1 from distanceThreshFromReference2 configured for Event D1 is greater than the distance between referenceLocation1 and referenceLocation2, it indicates that the base station has configured the “added indication 2”.

3. Configuring to satisfy an inequality Thresh21+ Thresh22<R2 in an original second distance event, to indicate that in the original second distance event, a fifth condition is always true and a sixth condition is always false;
wherein the original second distance event is: eventD2 in the 3GPP;
Thresh21 is a distance threshold corresponding to a first moving reference location (a moving reference location associated with a serving cell in eventD2), i.e., distanceThreshFromReference1 in eventD2;
Thresh22 is a distance threshold corresponding to a second moving reference location (a moving reference location associated with a neighbour cell in eventD2), i.e., distanceThreshFromReference2 in eventD2;
R2 is a distance between the first moving reference location and the second moving reference location;
the fifth condition is: Ml21-Hys>Thresh21, i.e., the fifth condition is Inequality D2-1 in eventD2; and
the sixth condition is: Ml21+Hys<Thresh21, i.e., the sixth condition is Inequality D2-3 in eventD2.

When a sum of distanceThreshFromReference1 and distanceThreshFromReference2 configured for Event D2 is less than the distance between the moving reference location of the serving cell and the moving reference location of the neighbour cell, it indicates that the base station has configured the “added indication 3”.

4. Configuring to satisfy an inequality Thresh22- Thresh21>R2 in the original second distance event, to indicate that in the original second distance event, a seventh condition is always true and an eighth condition is always false;
wherein the original second distance event is: eventD2 in the 3GPP;
Thresh22 is a distance threshold corresponding to a second moving reference location (a moving reference location associated with a neighbour cell in eventD2), i.e., distanceThreshFromReference2 in eventD2;
Thresh21 is a distance threshold corresponding to a first moving reference location (a moving reference location associated with a serving cell in eventD2), i.e., distanceThreshFromReference1 in eventD2;
R2 is a distance between the first moving reference location and the second moving reference location;
the seventh condition is: Ml22+Hys<Thresh22, i.e., the seventh condition is Inequality D2-2 in eventD2;
the eighth condition is: Ml22-Hys>Thresh22, i.e., the eighth condition is Inequality D2-4 in eventD2.

When a difference obtained by subtracting distanceThreshFromReference1 from distanceThreshFromReference2 configured for Event D2 is greater than the distance between the moving reference location of the serving cell and the moving reference location of the neighbour cell, it indicates that the base station has configured the “added indication 4”.

In which, Ml11 is a distance between the terminal device and the first fixed reference location, Hys is a distance hysteresis parameter, Thresh11 is a distance threshold corresponding to the first fixed reference location, Ml12 is a distance between the terminal device and the second fixed reference location, Thresh12 is a distance threshold corresponding to the second fixed reference location, Ml21 is a distance between the terminal device and the first moving reference location, Thresh21 is a distance threshold corresponding to the first moving reference location, Ml22 is a distance between the terminal device and the second moving reference location, and Thresh22 is a distance threshold corresponding to the second moving reference location.

IV. Indication mode 4 (explicitly expressing an added indication by adding indication information elements)

In some embodiments of the present disclosure, the ignoring a part of conditions in an original distance event based on indication information may include: ignoring a part of conditions in the original distance event by adding indication information elements. In this way, the indication information can be characterized more clearly and directly, and the modifications to the existing 3GPP protocols are relatively minor.

In some embodiments of the present disclosure, the ignoring a part of conditions in the original distance event by adding indication information elements may specifically include:

1. Adding a first indication information element to a specific message, to indicate that in an original first distance event, a first condition is always true and a second condition is always false;
wherein the original first distance event is: eventD1 in the 3GPP;
the first condition is: Ml11-Hys>Thresh11, i.e., the first condition is Inequality D1-1 in eventD1;
the second condition is: Ml11+Hys<Thresh11, i.e., the second condition is Inequality D1-3 in eventD1.

2. Adding a second indication information element to the specific message, to indicate that in the original first distance event, a third condition is always true and a fourth condition is always false;
wherein the original first distance event is: eventD1 in the 3GPP;
the third condition is: Ml12+Hys<Thresh12, i.e., the third condition is Inequality D1-2 in eventD1;
the fourth condition is: Ml12-Hys>Thresh12, i.e., the fourth condition is Inequality D1-4 in eventD1.

3. Adding a third indication information element to a specific message, to indicate that in an original second distance event, a fifth condition is always true and a sixth condition is always false;
wherein the original second distance event is: eventD2 in the 3GPP;
the fifth condition is: Ml21-Hys>Thresh21, i.e., the fifth condition is Inequality D2-1 in eventD2; and
the sixth condition is: Ml21+Hys<Thresh21, i.e., the sixth condition is Inequality D2-3 in eventD2.

4. Adding a fourth indication information element to the specific message, to indicate that in the original second distance event, a seventh condition is always true and an eighth condition is always false;
wherein the original second distance event is: eventD2 in the 3GPP;
the seventh condition is: Ml22+Hys<Thresh22, i.e., the seventh condition is Inequality D2-2 in eventD2; and
the eighth condition is: Ml22-Hys>Thresh22, i.e., the eighth condition is Inequality D2-4 in eventD2.

The specific message may be an RRC reconfiguration message (RRCReconfiguration); for example, indication information elements 1, 2, 3 and 4 may be directly added by extension to an event trigger configuration (EventTriggerConfig) and a condition trigger configuration (CondTriggerConfig), so as to represent the four types of “added indications”, respectively.

II. Added circular area-based distance event

In some embodiments of the present disclosure, a new distance event may also be introduced to facilitate the base station in monitoring the terminal's entry into a circular area. In this scenario, the configuring a distance event including a circular subarea described by a single reference location and a single distance threshold may include: adding a distance event that includes a circular subarea described by a single reference location and a single distance threshold. In this way, the indication information can be characterized more flexibly.

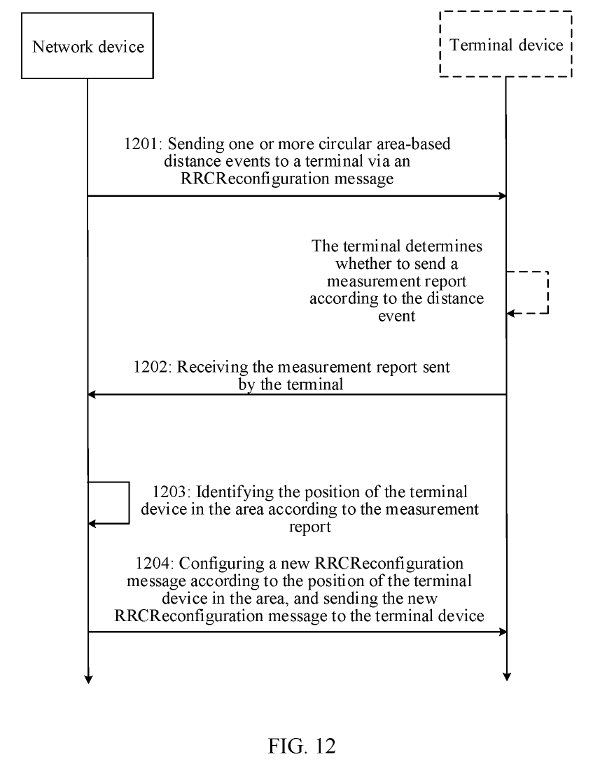

For example, a new distance Event Dx (wherein x is a numerical identifier, and Dx represents a new measurement event, such as D3) may be introduced. The parameters describing the distance and the position of the event mainly include: a fixed reference location (referenceLocation) and a distance threshold (distanceThreshFromReference). If the terminal enters a circular area formed with the reference location as a center and the distance threshold as a radius, the entering condition of the event is satisfied (for example, the terminal moves from point A to point B in FIG. 11). Accordingly, the terminal may send a measurement report to the base station, or transmit UE Assistance Information (UAI), or trigger a predefined action such as Conditional Handover (CHO). If, after the terminal entering the circular area and sending a measurement report, the terminal leaves the circular area, the leaving condition of the measurement event is deemed to be satisfied (e.g., the terminal moves from point B to point A in FIG. 11).

In some embodiments of the present disclosure, the adding a distance event that includes a circular subarea described by a single reference location and a single distance threshold may specifically include:

1. Adding a third distance event that includes a circular subarea described by a single fixed reference location and a single distance threshold, wherein the third distance event includes a first entering condition and a first leaving condition for the circular subarea;
wherein the third distance event may be added Event D3;
the first entering condition includes an inequality Ml1+Hys<T1;
the first leaving condition includes an inequality Ml1-Hys>T1;
Ml1 is a distance between the terminal device and a fixed reference location, Hys is a distance hysteresis parameter corresponding to the fixed reference location, and T1 is a distance threshold corresponding to the fixed reference location.

2. Adding a fourth distance event that includes a circular subarea described by a single moving reference location and a single distance threshold, wherein the fourth distance event includes: a second entering condition and a second leaving condition for the circular subarea, and epoch time and ephemeris information corresponding to the reference location;
wherein the fourth distance event may be added Event D4;
the second entering condition includes an inequality Ml2+Hys<T2;
the second leaving condition includes an inequality Ml2-Hys>T2;
wherein Ml2 is a distance between the terminal device and a moving reference location, Hys is a distance hysteresis parameter corresponding to the moving reference location, and T2 is a distance threshold corresponding to the moving reference location.

In some embodiments of the present disclosure, the sending a configuration message (e.g., an RRC reconfiguration message) carrying the distance event to a terminal device may include: sending an RRC reconfiguration message carrying a measurement configuration to a terminal device, wherein the measurement configuration includes an event trigger configuration for a measurement report or a condition trigger configuration for conditional handover, wherein the event trigger configuration or the condition trigger configuration includes the distance event.

In some embodiments of the present disclosure, the performing a predefined action may include: sending a measurement report based on the distance event to the network device.

In some other embodiments of the present disclosure, the performing a predefined action may include: sending UE assistance information based on the distance event to the network device, wherein the UE assistance information carries the relative position information of the terminal in the circular subarea (e.g., inside or outside the circular subarea).

In some other embodiments of the present disclosure, the performing a predefined action may include executing conditional handover (e.g., the terminal hands over from a cell covering one area to a cell covering another area, or hands over from a cell covering one subarea to a cell covering another subarea).

FIG. 12 illustrates a flowchart of a distance event configuration method in a wireless communication network according to some other embodiments of the present disclosure. As illustrated in FIG. 12, the distance event configuration method may include the following steps.

Step 1201: A base station sends one or more circular area-based distance events to a terminal via an RRCReconfiguration message.

Step 1202: Receiving a measurement report sent by the terminal; wherein the terminal may measure and evaluate the distance events, and send a measurement report (MeasurementReport) to the base station when a measurement report trigger condition is satisfied, wherein each circular area-based distance event corresponds to one MeasurementReport.

Step 1203: Identifying the position of the terminal device in the area according to the measurement report.

In which, the position of the terminal device in the area may include:
1. The terminal is located within a central area of a certain area (e.g., the coverage area of a beam or a cell).

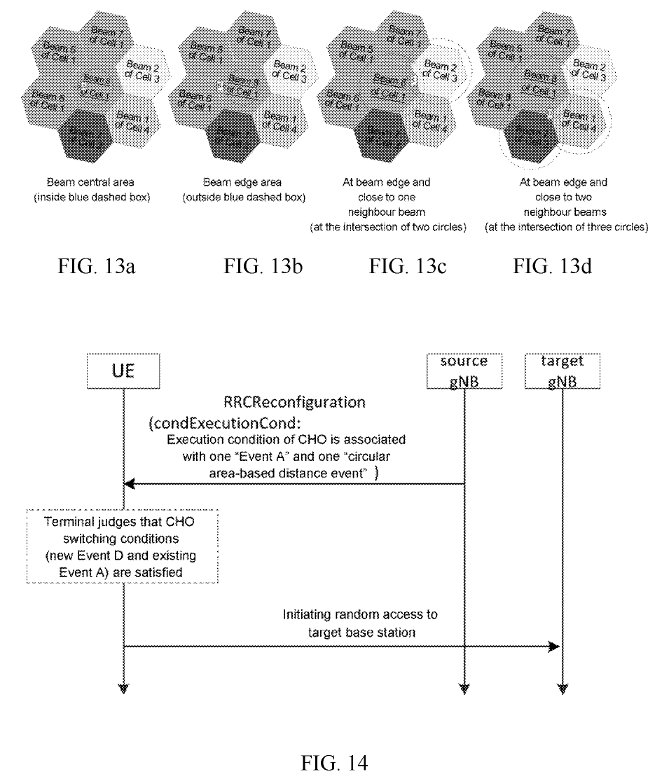

As illustrated in FIG. 13a, the circular area indicated by a dashed line is a central area of Beam 8 of Cell 1, and Terminal A is located within this central area.

2. The terminal is located within an edge area of a certain area (e.g., the coverage area of a beam or a cell).

As illustrated in FIG. 13b, the circular area indicated by a dashed line is a central area of Beam 8 of Cell 1, and Terminal B is located within the coverage outside the central area of Beam 8 of Cell 1, i.e., Terminal B is located within the edge area of this Beam 8.

3. The terminal is located at the boundary of two areas (e.g., the coverage areas of beams or cells) (requiring the configuration of 2 circular distance events).

As illustrated in FIG. 13c, a circular area indicated by a left dashed line is the coverage of Beam 8 of Cell 1, and a circular area indicated by a right dashed line is the coverage of Beam 2 of Cell 3; Terminal C is located within the coverages of both Beam 8 and Beam 2 at the same time, i.e., Terminal C is located in an overlapping area of these two coverages.

4. The terminal is located at the boundary of three or more areas (e.g., the coverage areas of beams or cells) (requiring the configuration of 3 circular distance events).

As illustrated in FIG. 13d, the three circular areas indicated by the dashed lines represent: the coverage of Beam 8 of Cell 1, the coverage of Beam 7 of Cell 2, and the coverage of Beam 1 of Cell 4, respectively; Terminal D is located within the coverages of Beam 8, Beam 7 and Beam 1 at the same time, i.e., Terminal D is located in an overlapping area of the three coverages.

Step 1204: Configuring a new RRCReconfiguration message according to the position of the terminal device in the area, and sending the new RRCReconfiguration message to the terminal device.

In which, the new configuration message includes any one of:
a configuration message indicating that the terminal device initiates signal strength measurement;
a configuration message indicating that the terminal device updates a measurement gap configuration and an SSB measurement timing configuration;
a configuration message indicating that the terminal device performs handover or conditional handover.

As illustrated in FIG. 14, the configuration message indicating that the terminal device performs handover or conditional handover may be sent to the terminal via an RRC reconfiguration message or the like, and the conditional handover configured in the RRC reconfiguration message may be associated with one or two events simultaneously: a circular area-based distance event and a conventional signal strength event (e.g., event A4). When a terminal (UE) hands over from a source base station (source gNB) to a target base station (target gNB), the terminal may judge whether to enter the coverage area of the target gNB according to the circular area-based distance event, and judge the measured signal strength of the target gNB based on eventA4 at the same time, thus triggering the conditional handover according to the combined conditions of these two events.

Based on the above embodiments of the distance event configuration method in the wireless communication network, for an NTN scenario, the base station can obtain area information, such as the beam which covers the terminal, whether the terminal is at the center or the edge of the beam, and the direction in which the terminal is adjacent to the beam. In an TN-NTN interoperation scenario, the NTN network can know that the terminal enters or leaves a TN cell.

III. Removing associations between the reference locations and the cells in the original distance event

In some other embodiments of the present disclosure, the configuring a distance event including subareas for describing an area may include:

1. Removing an association between a first reference location in an original distance event and a serving cell, and removing an association between a second reference location in the original distance event and a neighbour cell.

In the existing 3GPP protocols, an unnecessary restriction is imposed on associable positions of the reference locations for Event D1 in the EventTriggerConfig field: referenceLocation1 is associated with the serving cell, and referenceLocation2 is associated with the neighbour cell. In some embodiments of the present disclosure, referenceLocation1 and referenceLocation2 in Event D1 may be extended to be both associable with the serving cell and the neighbour cell, and may also be associated with a plurality of positions within a cell (e.g., may be associated with the central positions of a plurality of beams within a cell).

In addition, in the existing 3GPP protocols, an unnecessary restriction is also imposed on the associable positions of the reference locations for Event D2 in the EventTriggerConfig field: among the two moving reference locations configurable for Event D2, the reference location 1 is configured in SIB19 for the association with the serving cell, the reference location 2 is configured in NTN-NeighbourCellInfo-r18 of a measurement object NR (MeasObjectNR) for the association with the neighbour cell, and only one reference location 2 is configurable for each neighbour cell. However, in some embodiments of the present disclosure, the reference locations configurable for Event D2 may be extended, so that two independently configurable moving reference locations, which are corresponding to the moving reference location 1 (moving referenceLocation1) and the moving reference location 2 (moving referenceLocation2) respectively, can be configured for each Event D2. Both of the moving reference locations may be associated with either the serving cell or the neighbour cell. In which, the data structure of an independently configurable moving reference location may additionally require configuration of epoch time (epochTime) and ephemeris inforamtion (ephemerisInfo), in addition to the position coordinate parameters of the reference location (referenceLocation), that is, a single independently configurable moving reference location is characterized jointly by referenceLocation, epochTime and ephemerisInfo.

2. Describing subareas of an area based on the distance event with the associations removed.

After removing the restrictions on the associable positions of the reference locations in the existing 3GPP protocols, the extended Event D1 and Event D2 can both freely characterize a serving cell (or the subareas within it) and a neighbour cell (or the subareas within it), thereby improving the applicable scope of the distance events in the wireless communication network.

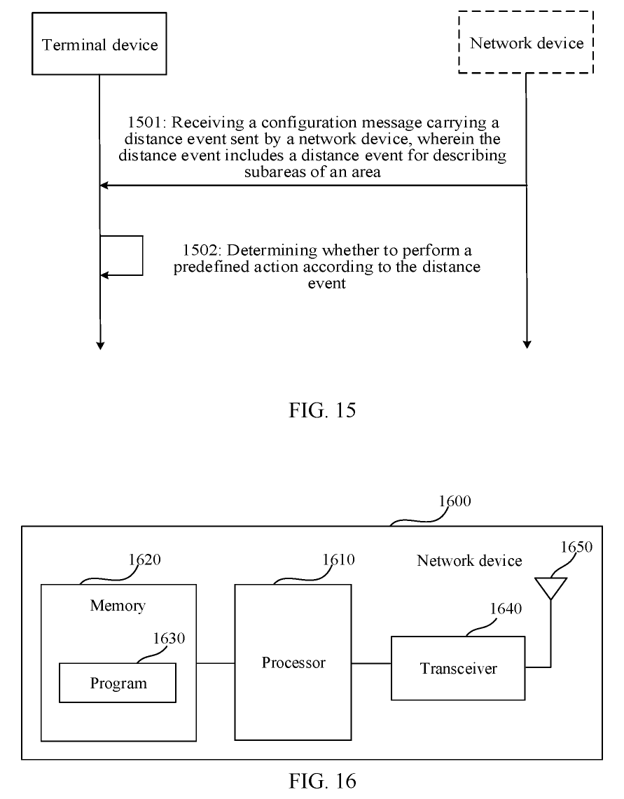

An embodiment of the present disclosure provides a distance event triggering method in a wireless communication network, which can be applied to the terminal device side described above. As illustrated in FIG. 15, in some embodiments of the present disclosure, the distance event triggering method in the wireless communication network may include the following steps.

Step 1501: Receiving a configuration message carrying a distance event sent by a network device, wherein the distance event includes a distance event for describing subareas of an area.

Step 1502: Determining whether to perform a predefined action according to the distance event.

In the distance event triggering method in the wireless communication network according to some embodiments of the present disclosure, the configuration message of the distance event includes:
configuration information of a distance event for a circular subarea described by a single reference location and a single distance threshold.

In the distance event triggering method in the wireless communication network according to some embodiments of the present disclosure, the subarea includes any one of:
a cell coverage area; and
a beam coverage area.

In the distance event triggering method in the wireless communication network according to some embodiments of the present disclosure, the receiving a configuration message carrying a distance event sent by a network device includes:
receiving a configuration message carrying a measurement configuration sent by a network device, wherein the measurement configuration includes an event trigger configuration for a measurement report or a condition trigger configuration for conditional handover, and the event trigger configuration and the condition trigger configuration include the distance event.

In the distance event triggering method in the wireless communication network according to some embodiments of the present disclosure, the performing a predefined action includes one of:
sending a measurement report based on the distance event to the network device;
sending UE assistance information based on the distance event to the network device; and
performing conditional handover.

Although the process flows described above include a plurality of operations occurring in a specific order, it shall be clearly understood that these processes may include more or fewer operations, and these operations may be performed sequentially or in parallel (e.g., using a parallel processor or in a multi-threaded environment).

An embodiment of the present disclosure further provides a distance event configuration apparatus in a wireless communication network, including:
a configuration module configured to configure a distance event including subareas for describing an area;
a sending module configured to send a configuration message carrying the distance event to a terminal device, so that the terminal device determines whether to perform a predefined action according to the distance event.

An embodiment of the present disclosure further provides a distance event triggering apparatus in a wireless communication network, including:
a receiving module configured to receive a configuration message carrying one or more distance events sent by a network device, wherein the distance event includes a distance event for describing subareas of an area;
a determination module configured to determine whether to perform a predefined action according to the distance event.

An embodiment of the present disclosure further provides a network device, which may be a base station for example, but the present disclosure is not limited thereto and may also adopt any other network device.

FIG. 16 illustrates a structural diagram of a network device according to an embodiment of the present disclosure. As illustrated in FIG. 16, the network device 1600 may include a processor 1610 (e.g., a central processing unit (CPU)) and a memory 1620 that is coupled to the processor 1610. The memory 1620 may store various types of data and further store a program 1630 for information processing, and the program 1630 is executed under the control of the processor 1610.

For example, the processor 1610 may be configured to execute the program to implement the distance event configuration method in the wireless communication network as described in the foregoing embodiments. For example, the processor 1610 may be configured to perform the following controls: configuring a distance event including subareas for describing an area; and sending a configuration message carrying the distance event to a terminal device, so that the terminal device determines whether to perform a predefined action according to the distance event.

In addition, as illustrated in FIG. 16, the network device 1600 may further include a transceiver 1640 and an antenna 1650, etc. The functions of the above components are similar to those in the prior art, and will not be repeated here. It shall be noted that the network device 1600 does not necessarily include all the components illustrated in FIG. 16. In addition, the network device 1600 may further include components not illustrated in FIG. 16, which may refer to the prior art.

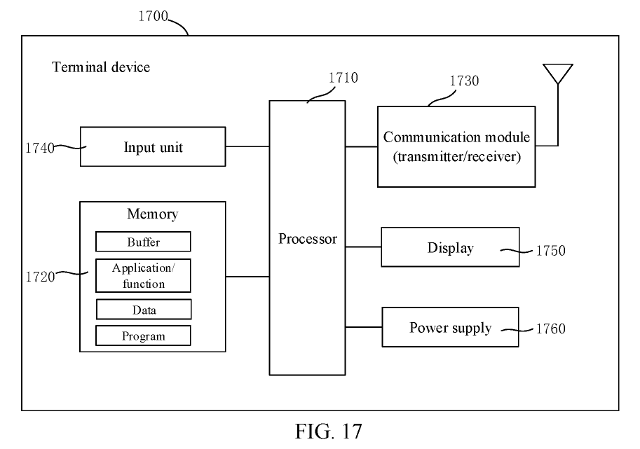

An embodiment of the present disclosure further provides a terminal device. As illustrated in FIG. 17, the terminal device 1700 may include a processor 1710 and a memory 1720; the memory 1720 stores data and a program and is coupled to the processor 1710. It shall be noted that this figure is exemplary, and any other type of structure may also be used to supplement or replace this structure to realize telecommunication functions or other functions.

For example, the processor 1710 may be configured to execute the programs to implement the distance event triggering method in the wireless communication network as described in the foregoing embodiments. For example, the processor 1710 may be configured to perform the following controls: receiving a message carrying a distance event sent by a network device, wherein the distance event includes an area described by a single reference location and a single distance threshold; and determining whether to perform a predefined action according to the distance event.

As illustrated in FIG. 17, the terminal device 1700 may further include a communication module 1730, an input unit 1740, a display 1750 and a power supply 1760. The functions of the above components are similar to those in the prior art, and will not be repeated here. It shall be noted that the terminal device 1700 does not necessarily include all the components illustrated in FIG. 17, and the above components are not essential. In addition, the terminal device 1700 may further include components not illustrated in FIG. 17, which may refer to the prior art.

For the convenience of description, the above apparatus is described by being divided into various units in terms of function. Of course, during implementation of the present disclosure, the functions of various units may be implemented in one or more pieces of software and/or hardware.

An embodiment of the present disclosure further provides a computer storage medium which stores instructions thereon, wherein when executed individually or collectively by at least one processor of a computer device, the instructions cause the computer device to perform the distance event configuring or triggering method in the wireless communication network.

The present disclosure is described with reference to a flowchart and/or a block diagram of the method, the device (system), the computer-readable storage medium and the computer program product according to some embodiments of the present disclosure. It shall be appreciated that each flow and/or block in the flowchart and/or the block diagram and a combination of flows and/or blocks in the flowchart and/or the block diagram can be realized by computer program instructions. Those computer program instructions can be provided to a general computer, a dedicated computer, an embedded processor or a processor of other programmable data processing device to produce a machine, so that the instructions executed by the processor of the computer or other programmable data processing device produce means for realizing specified functions in one or more flows in the flowchart and/or one or more blocks in the block diagram.

These computer program instructions may also be stored in a computer readable memory capable of guiding the computer or other programmable data processing devices to work in a particular manner, so that the instructions stored in the computer readable memory produce manufacture articles including an instructing device which realizes function(s) specified in one or more flows in the flowchart and/or one or more blocks in the block diagram.

These computer program instructions may also be loaded onto the computer or other programmable data processing devices, so that a series of operation steps are performed on the computer or other programmable devices to produce a processing realized by the computer, thus the instructions executed on the computer or other programmable devices provide step(s) for realizing function(s) specified in one or more flows in the flowchart and/or one or more blocks in the block diagram.

In a typical configuration, the computing device includes one or more processors (CPUs), an input/output interface, a network interface and a memory.

The memory may have the form of a volatile memory, a Random-Access Memory (RAM) and/or a nonvolatile memory such as Read-Only Memory (ROM) or a flash RAM, etc. among the computer readable medium. The memory is an example of the computer readable medium.

The computer-readable medium includes permanent and non-permanent, removable and non-removable media, which can realize the information storage in any method or technique. The information can be computer readable instructions, data structures, program modules or other data. An example of the computer storage medium includes, but not limited to, a Phase-Change Random-access Memory (PRAM), a static random access memory (SRAM), a dynamic random access memory (DRAM), other types of random access memory (RAM), a read-only memory (ROM), an electrically-erasable programmable read-only memory (EEPROM), a flash memory or other memory techniques, a compact disk read only memory (CD-ROM), a digital versatile disc (DVD) or other optical storages, magnetic cassette tapes, magnetic diskette storage or other magnetic storage device or any other non-transmission medium, which can be used for the storage of information accessible to a computing device. According to the definitions herein, the computer readable medium does not include transitory media, such as modulated data signal and carrier wave.

Those skilled in the art shall appreciate that the embodiments of the present disclosure can be provided as methods, systems or computer program products. Therefore, the embodiments of the present disclosure can take the form of a full hardware embodiment, a full software embodiment, or an embodiment combining software and hardware. Moreover, the embodiments of the present disclosure can take the form of a computer program product implemented on one or more computer usable storage mediums (including, but not limited to, a magnetic disc memory, CD-ROM, optical storage, etc.) containing therein computer usable program codes.

The embodiments of the present disclosure may be described in the general context of computer executable instructions executed by the computer, e.g., the program module. In general, the program module includes routine, program, object, component, data structure, etc. executing a particular task or realizing a particular abstract data type. The embodiments of the present disclosure may also be put into practice in the distributed computing environments in which tasks are executed by remote processing devices connected through a communication network. In the distributed computing environments, the program modules may be located in the local and remote computer storage medium including the storage device.

It shall also be understood that in the embodiments of the present disclosure, the term “and/or” is only an association relationship that describes the associated objects, indicating that there may be three relationships. For example, A and/or B may indicate the three cases: A exists alone, A and B both exist, and B exists alone. In addition, the character “/” in the present disclosure generally indicates that the contextually associated objects are in an “or” relationship.

The various embodiments of the present disclosure are all described in a progressive manner, and the same or similar portions of the various embodiments can refer to each other. Each embodiment lays an emphasis on its distinctions from other embodiments. In particular, the system embodiment is simply described since it is substantially similar to the method embodiment, and please refer to the descriptions of the method embodiment for the relevant portions.

In the description of the present disclosure, the description of reference terms “one embodiment”, “some embodiments”, “an example”, “a specific example” or “some examples” and the like mean that the specific features, structures, materials, or characteristics described in conjunction with the embodiment(s) or example(s) are included in at least one embodiment or example of the present disclosure. In the present disclosure, the schematic expressions of the above terms do not necessarily aim at the same embodiment or example. Moreover, the described specific features, structures, materials, or characteristics may be combined in any one or more embodiments or examples in a suitable manner. In addition, those skilled in the art can combine and integrate different embodiments or examples described in the present disclosure and features thereof if there is no contradiction to each other.

Those described above are merely embodiments of the present disclosure and are not intended to limit the present disclosure. For those skilled in the art, the present disclosure may have various modifications or variations. Any amendment, equivalent substitution, improvement, etc. made under the spirit and principle of the present disclosure shall fall within the scope of the claims of the present disclosure.

What is claimed is:

1. A distance event configuration method in a wireless communication network, which is applied to a network device side, the method comprising:
configuring a distance event including subareas for describing an area;
sending a configuration message carrying the distance event to a terminal device, so that the terminal device determines whether to perform a predefined action according to the distance event.

2. The distance event configuration method according to claim 1, wherein the configuring a distance event including subareas for describing an area includes:
configuring a distance event including a circular subarea described by a single reference location and a single distance threshold.

3. The distance event configuration method according to claim 1, wherein the configuring a distance event including subareas for describing an area includes:
removing an association between a first reference location in an original distance event and a serving cell, and removing an association between a second reference location in the original distance event and a neighbour cell;
describing the subareas of the area based on the distance event with the associations removed.

4. The distance event configuration method according to claim 2, wherein the configuring a distance event including a circular subarea described by a single reference location and a single distance threshold includes:
ignoring a part of conditions in an original distance event based on indication information, so that the original distance event includes the circular subarea described by the single reference location and the single distance threshold.

5. The distance event configuration method according to claim 4, wherein the ignoring a part of conditions in an original distance event based on indication information includes:
ignoring a part of conditions in the original distance event by indicating that a distance threshold in the original distance event is a specific value.

6. The distance event configuration method according to claim 5, wherein the ignoring a part of conditions in the original distance event by indicating that a distance threshold in the original distance event is a specific value includes: configuring a distance threshold corresponding to a first fixed reference location in an original first distance event to be a first specific value, to indicate that in the original first distance event, a first condition is always true and a second condition is always false; configuring a distance threshold corresponding to a second fixed reference location in the original first distance event to be a second specific value, to indicate that in the original first distance event, a third condition is always true and a fourth condition is always false; wherein the first condition is: M/11-Hys>Thresh11, the second condition is: M/11+Hys<Thresh11, the third condition is: M/12+Hys<Thresh12, the fourth condition is: M/12-Hys>Thresh12, M/11 is a distance between the terminal device and the first fixed reference location, Hys is a distance hysteresis parameter, Thresh1 is the distance threshold corresponding to the first fixed reference location, M/12 is a distance between the terminal device and the second fixed reference location, and Thresh is the distance threshold corresponding to the second fixed reference location; and/or
wherein the ignoring a part of conditions in the original distance event by indicating that a distance threshold in the original distance event is a specific value includes: configuring a distance threshold corresponding to a first moving reference location in an original second distance event to be a third specific value, to indicate that in the original second distance event, a fifth condition is always true and a sixth condition is always false; configuring a distance threshold corresponding to a second moving reference location in the original second distance event to be a fourth specific value, to indicate that in the original second distance event, a seventh condition is always true and an eighth condition is always false; wherein the fifth condition is: M/21-Hys>Thresh21, the sixth condition is: M/21+Hys<Thresh21, the seventh condition is: M/22+Hys<Thresh22, the eighth condition is: M/22-Hys>Thresh22, M/21 is a distance between the terminal device and the first moving reference location, Hys is a distance hysteresis parameter, Thresh21 is the distance threshold corresponding to the first moving reference location, M/22 is a distance between the terminal device and the second moving reference location, and Thresh22 is the distance threshold corresponding to the second moving reference location

7. The distance event configuration method according to claim 4, wherein the ignoring a part of conditions in an original distance event based on indication information includes:
ignoring a part of conditions in the original distance event by indicating that a reference location position in the original distance event is a specific value.

8. The distance event configuration method according to claim 7, wherein the ignoring a part of conditions in the original distance event by indicating that a reference location position in the original distance event is a specific value includes: configuring a position of a first fixed reference location in an original first distance event to be a fifth specific value, to indicate that in the original first distance event, a first condition is always true and a second condition is always false; configuring a position of a second fixed reference location in the original first distance event to be a sixth specific value, to indicate that in the original first distance event, a third condition is always true and a fourth condition is always false; wherein the first condition is: M/11-Hys>Thresh11 the second condition is: M/11+Hys<Thresh11, the third condition is: M/12+Hys<Thresh12, the fourth condition is: M/12-Hys>Thresh12, M/11 is a distance between the terminal device and the first fixed reference location, Hys is a distance hysteresis parameter, Thresh1 is a distance threshold corresponding to the first fixed reference location, M/12 is a distance between the terminal device and the second fixed reference location, and Thresh 12 is a distance threshold corresponding to the second fixed reference location; and/or
wherein the ignoring a part of conditions in the original distance event by indicating that a reference location position in the original distance event is a specific value includes:
configuring a position of a first moving reference location in an original second distance event to be a seventh specific value, to indicate that in the original second distance event, a fifth condition is always true and a sixth condition is always false;
configuring a position of a second moving reference location in the original second distance event to be an eighth specific value, to indicate that in the original second distance event, a seventh condition is always true and an eighth condition is always false;
wherein the fifth condition is: M/21-Hys>Thresh21, the sixth condition is: M/21+Hys<Thresh21, the seventh condition is: M/22+Hys<Thresh22, the eighth condition is: M/22-Hys>Thresh22, M/21 is a distance between the terminal device and the first moving reference location, Hys is a distance hysteresis parameter, Thresh21 is a distance threshold corresponding to the first moving reference location, M/22 is a distance between the terminal device and the second moving reference location, and Thresh22 is a distance threshold corresponding to the second moving reference location.

9. The distance event configuration method according to claim 4, wherein the ignoring a part of conditions in an original distance event based on indication information includes:
ignoring a part of conditions in the original distance event by indicating that the distance threshold and the reference location in the original distance event satisfy a specific relationship.

10. The distance event configuration method according to claim 9, wherein the ignoring a part of conditions in the original distance event by indicating that the distance threshold and the reference location in the original distance event satisfy a specific relationship includes: configuring to satisfy an inequality Thresh Thresh12<R1 in an original first distance event, to indicate that in the original first distance event, a first condition is always true and a second condition is always false; configuring to satisfy an inequality Thresh12- Thresh11>R1 in the original first distance event, to indicate that in the original first distance event, a third condition is always true and a fourth condition is always false; wherein Thresh11 is a distance threshold corresponding to a first fixed reference location, Thresh12 is a distance threshold corresponding to a second fixed reference location, R1 is a distance between the first fixed reference location and the second fixed reference location, the first condition is: M/11-Hys>Thresh11, the second condition is: M/11+Hys<Thresh11, the third condition is: M/12+Hys<Thresh12, the fourth condition is: M/12- Hys>Thresh12, M/11 is a distance between the terminal device and the first fixed reference location, Hys is a distance hysteresis parameter, M/12 is a distance between the terminal device and the second fixed reference location; and/or
wherein the ignoring a part of conditions in the original distance event by indicating that the distance threshold and the reference location in the original distance event satisfy a specific relationship includes: configuring to satisfy an inequality Thresh21+ Thresh22<R2 in an original second distance event, to indicate that in the original second distance event, a fifth condition is always true and a sixth condition is always false; configuring to satisfy an inequality Thresh22- Thresh21>R2 in the original second distance event, to indicate that in the original second distance event, a seventh condition is always true and an eighth condition is always false; wherein Thresh21 is a distance threshold corresponding to a first moving reference location, Thresh22 is a distance threshold corresponding to a second moving reference location, R2 is a distance between the first moving reference location and the second moving reference location, the fifth condition is: M/21- Hys>Thresh21, the sixth condition is: M/21+Hys<Thresh21, the seventh condition is: M/22+Hys<Thresh22, the eighth condition is: M/22-Hys>Thresh22, M/21 is a distance between the terminal device and the first moving reference location, Hys is a distance hysteresis parameter, M/22 is a distance between the terminal device and the second moving reference location.

11. The distance event configuration method according to claim 4, wherein the ignoring a part of conditions in an original distance event based on indication information includes:
ignoring a part of conditions in the original distance event by adding indication information elements.

12. The distance event configuration method according to claim 11, wherein the ignoring a part of conditions in the original distance event by adding indication information elements includes: adding a first indication information element to a specific message, to indicate that in an original first distance event, a first condition is always true and a second condition is always false; adding a second indication information element to the specific message, to indicate that in the original first distance event, a third condition is always true and a fourth condition is always false; wherein the first condition is: M/11-Hys>Thresh11, the second condition is: M/11+Hys<Thresh11, the third condition is: M/12+Hys<Thresh12, the fourth condition is: M/12-Hys>Thresh12, M/11 is a distance between the terminal device and a first fixed reference location, Hys is a distance hysteresis parameter, Thresh11 is a distance threshold corresponding to the first fixed reference location, M/12 is a distance between the terminal device and a second fixed reference location, and Thresh is a distance threshold corresponding to the second fixed reference location; and/or
wherein the ignoring a part of conditions in the original distance event by adding indication information elements includes: adding a third indication information element to a specific message, to indicate that in an original second distance event, a fifth condition is always true and a sixth condition is always false; and adding a fourth indication information element to the specific message, to indicate that in the original second distance event, a seventh condition is always true and an eighth condition is always false; wherein the fifth condition is: M/21-Hys>Thresh21, the sixth condition is: M/21+Hys<Thresh21, the seventh condition is: M/22+Hys<Thresh22, the eighth condition is: M/22-Hys>Thresh22, M/21 is a distance between the terminal device and a first moving reference location, Hys is a distance hysteresis parameter, Thresh21 is a distance threshold corresponding to the first moving reference location, M/22 is a distance between the terminal device and a second moving reference location, and Thresh22 is a distance threshold corresponding to the second moving reference location.

13. The distance event configuration method according to claim 2, wherein the configuring a distance event including a circular subarea described by a single reference location and a single distance threshold includes:
adding a distance event that includes a circular subarea described by a single reference location and a single distance threshold.

14. The distance event configuration method according to claim 13, wherein the adding a distance event that includes a circular subarea described by a single reference location and a single distance threshold includes: adding a third distance event that includes a circular subarea described by a single fixed reference location and a single distance threshold, wherein the third distance event includes a first entering condition and a first leaving condition for the circular subarea, particularly wherein the first entering condition includes an inequality M/1+Hys<T1, and the first leaving condition includes an inequality M/1-Hys>T1; wherein M/1 is a distance between the terminal device and a fixed reference location, Hys is a distance hysteresis parameter corresponding to the fixed reference location, and T1 is a distance threshold corresponding to the fixed reference location; and/or
wherein the adding a distance event that includes a circular subarea described by a single reference location and a single distance threshold includes: adding a fourth distance event that includes a circular subarea described by a single moving reference location and a single distance threshold, wherein the fourth distance event includes: a second entering condition and a second leaving condition for the circular subarea, and epoch time and ephemeris information corresponding to the reference location, particularly wherein the second entering condition includes an inequality M/2+Hys<T2, and the second leaving condition includes an inequality M/2- Hys>T2; wherein M/2 is a distance between the terminal device and a moving reference location, Hys is a distance hysteresis parameter corresponding to the moving reference location, and T2 is a distance threshold corresponding to the moving reference location.

15. The distance event configuration method according to claim 1, wherein the subarea includes any one of: a cell coverage area; and a beam coverage area; and/or
wherein the sending a configuration message carrying the distance event to a terminal device includes: sending a configuration message carrying a measurement configuration to a terminal device, wherein the measurement configuration includes an event trigger configuration for a measurement report or a condition trigger configuration for conditional handover, wherein the event trigger configuration or the condition trigger configuration includes the distance event; and/or
wherein the performing a predefined action includes one of: sending a measurement report based on the distance event to the network device; sending user equipment assistance information based on the distance event to the network device; and performing conditional handover, particularly wherein the distance event configuration method further includes: identifying a position of the terminal device in the area according to the measurement report or the user equipment assistance information; configuring a new configuration message according to the position of the terminal device in the area; sending the new configuration message to the terminal device, more particularly wherein the new configuration message includes any one of: a configuration message indicating that the terminal device initiates signal strength measurement; a configuration message indicating that the terminal device updates a measurement gap configuration and an SSB measurement timing configuration; and a configuration message indicating that the terminal device performs handover or conditional handover.

16. A distance event triggering method in a wireless communication network, which is applied to a terminal device side, the method comprising:
receiving a configuration message carrying a distance event sent by a network device, wherein the distance event includes a distance event for describing subareas of an area; and
determining whether to perform a predefined action according to the distance event.

17. The distance event triggering method according to claim 16, wherein the configuration message of the distance event includes:
configuration information of a distance event for a circular subarea described by a single reference location and a single distance threshold.

18. The distance event triggering method according to claim 16, wherein the subarea includes any one of:
a cell coverage area; and
a beam coverage area.

19. The distance event triggering method according to claim 16, wherein the receiving a configuration message carrying a distance event sent by a network device includes:
receiving a configuration message carrying a measurement configuration sent by the network device, wherein the measurement configuration includes an event trigger configuration for a measurement report or a condition trigger configuration for conditional handover, wherein the event trigger configuration or the condition trigger configuration includes the distance event; and/or
wherein the performing a predefined action includes one of: sending a measurement report based on the distance event to the network device; sending user equipment assistance information based on the distance event to the network device; and performing conditional handover.

20. A terminal device, comprising:
at least one processor; and
at least one memory which stores instructions thereon, wherein when executed individually or collectively by the at least one processor, the instructions cause the terminal device to perform the method according to claim 16.
